(19) United States
(12) Patent Application Publication
(10) Pub. No.: US 2015/0141029 A1
(43) Pub. Date: May 21, 2015

(54) BANDWIDTH PREDICTION FOR CELLULAR BACKHAULING

(71) Applicant: Elbit Systems Land and C4I Ltd., Natania (IL)

(72) Inventors: Joseph Guttman, Petach-Tikva (IL); Shlomo Nizri, Natania (IL)

(21) Appl. No.: 14/401,584

(22) PCT Filed: May 16, 2013
(86) PCT No.: PCT/IL2013/050418

§ 371 Date: Nov. 17, 2014

(30) Foreign Application Priority Data
May 16, 2012 (IL) 219839

(51) Int. Cl. H04W 72/04

(52) U.S. Cl. CPC H04W 72/0486
USPC 455/452.1

(57) ABSTRACT

A bandwidth manager manages respective bandwidths for base stations in a communication network. The base stations are controlled by an access controller which dynamically allocates communication resources for the base stations. Each of the base stations has a respective allocated bandwidth. The bandwidth manager includes a signaling monitor and a bandwidth allocator. The signaling monitor monitors signaling between the access controller and at least one of the base stations so as to predict upcoming changes to a demand for communication resources for at least one monitored base station. The bandwidth allocator updates the respective allocated bandwidths in accordance with the predicted upcoming changes.

### FIELD AND BACKGROUND OF THE INVENTION

The present invention, in some embodiments thereof, relates to a system and method for bandwidth on demand for communication networks and, more particularly, but not exclusively, to monitoring signaling within the communication network to provide bandwidth on demand.

Current satellite communications systems typically operate in one of the following configurations:

1) Single channel per carrier (SCPC)—In the SCPC configuration the satellite bandwidth assigned to each satellite ground station (e.g. VSAT) is static. This configuration is simple and stable. However it suffers from a lack of flexibility since the maximal bandwidth is assigned at all times.

2) Bandwidth on demand (BOD)—In the BOD configuration bandwidth is assigned to each ground station according to current usage. This configuration is flexible, however it is sensitive to data loss, which can result in communication disconnects (e.g. lost telephone connections) and in severe cases a crash of the base transceiver station (BTS). Rural areas in which there is no land connection between the BTS and the base station controller (BSC) are particularly prone to such problems. Current BOD systems achieve 2-3% packet loss.

Cellular communication networks are particularly sensitive to packet loss, as they operate in real-time with no data retransmission. Efficient bandwidth utilization is particularly important for third generation (3G) data services which are provided over cellular communication links. Such services include video calls and Internet access with all of the available online applications.

Satellite cellular data networks are used to provide Internet and data services to rural area. A single satellite may encounter varying levels of demands from the different areas served. Bandwidth on demand may enable to dynamically allocate different amount of bandwidths to each area in order to provide larger bandwidths during times of high demand and utilizing the same bandwidth resources to a different areas during periods of low demand, enabling more efficient utilization of resources.

Currently BOD backhauling systems monitor input traffic and assign bandwidth according to current usage and other known parameters such as prioritization, type of data service and data rates assigned to various user groups (e.g. minimum and maximum data rates). These BOD systems can respond appropriately to gradual changes in bandwidth needs, but are sensitive to rapid rises in demand which overload the available bandwidth. Furthermore, current cellular backhauling systems have difficulty implementing a Quality of Service (QoS) mechanism for prioritizing different applications, due to the difficulty of monitoring different protocols transferred over the cellular communication network.

In light of these difficulties, the SCPC configuration currently is more widely used to avoid data loss, particularly during timing processes. This results in inefficient utilization of the available bandwidth.

### SUMMARY OF THE INVENTION

In some embodiments of the present invention, the signaling protocol between base stations and the access controller in a communication network is monitored passively. The information obtained from the monitored signaling protocol is analyzed and used to predict upcoming changes in base station bandwidth needs. Respective base station bandwidths over the satellite portion of the communication network are updated accordingly, prior to the actual increase in bandwidth needs. This may prevent or decrease packet loss caused by exceeding the currently allocated bandwidth.

According to an aspect of some embodiments of the present invention there is provided a bandwidth manager for base stations in a communication network, the base stations being controlled by an access controller to dynamically allocate communication resources for the base stations, each of the base stations having a respective allocated bandwidth, comprising: a signaling monitor, configured for monitoring signaling between the access controller and at least one of the base stations so as to predict upcoming changes to a demand for communication resources for at least one monitored base station; and a bandwidth allocator associated with the signaling monitor, configured for updating the respective allocated bandwidths in accordance with the predicted upcoming changes.

According to some embodiments of the invention, the respective allocated bandwidths comprise bandwidths for transmissions over a satellite portion of the communication network.

According to some embodiments of the invention, bandwidth allocator performs the updating prior to the implementation of the predicted upcoming change.

According to some embodiments of the invention, the communication network comprises a cellular communication network.

According to some embodiments of the invention, the communication network comprises an IP Multimedia Subsystem (IMS) compliant IP access network.

According to some embodiments of the invention, the signaling is over a signaling bearer between the access controller and the at least one base station.

According to some embodiments of the invention, the predicting comprises identifying signaling messages indicative of one of a resource type change and a resource bandwidth change for the at least one base station.

According to some embodiments of the invention, the predicting comprises identifying flow control indications of one of a resource type change and a resource bandwidth change for the at least one base station.

According to some embodiments of the invention, the signaling monitor identifies at least one of a bearer activation event, a bearer modification event and a bearer termination event indicative of a resource type change for the at least one base station.

According to some embodiments of the invention, the signaling monitor is further configured to analyze a requested bearer modification to identify an upcoming impact upon a total required resources of a base station, and the bandwidth allocator modifies an allocated bandwidth of the base station in accordance with the identified upcoming impact.

According to some embodiments of the invention, the signaling monitor identifies a signaling event indicative of an upcoming change in the data rate of an existing bearer of a base station.

According to some embodiments of the invention, the signaling monitor identifies a signaling event indicative of an upcoming allocation of a new bearer to a base station.

According to some embodiments of the invention, the signaling monitor identifies a signaling event indicative of an upcoming release of an existing bearer of a base station.

According to some embodiments of the invention, the signaling monitor derives a priority bit rate (PBR) associated with a bearer so as to determine a required bandwidth for the bearer.

According to some embodiments of the invention, the deriving is from information provided by signaling messages and flow control indications.

According to some embodiments of the invention, the bandwidth manager further comprises a Quality of Service manager configured for implementing differentiation between bearers and quality of services prioritizations in accordance with information provided by signaling messages and flow control indications.

According to some embodiments of the invention, the communication network comprises a Universal Mobile Telecommunications System (UMTS) network, the access controller comprises a Radio Network controller (RNC) and the at least one base station comprises a Node B.

According to some embodiments of the invention, the communication network comprises a Global System for Mobile communication (GSM) network, the access controller comprises a GSM base station controller (BSC) and the at least one base station comprises a base transceiver station (BTS).

According to an aspect of some embodiments of the present invention there is provided a communication network with bandwidth management, the communication being over communication channels established toward base stations, comprising: a plurality of base stations, configured for communicating over communication channels, at least one of the base stations having a dynamically-allocatable respective bandwidth for the communicating; an access controller associated with the base stations, configured for managing communication resources for the base stations; a signaling monitor associated with the access controller, configured for monitoring signaling between the access controller and at least one of the base stations to predict upcoming changes to respective data rates of the monitored base stations; and a bandwidth allocator associated with the signaling monitor, configured for updating the respective dynamically-allocatable bandwidths in accordance with the predicted upcoming changes.

According to some embodiments of the invention, the dynamically-allocatable respective bandwidths comprise bandwidths for transmissions over a satellite portion of the communication network.

According to some embodiments of the invention, the bandwidth allocator provides the updated bandwidths to a BOD controller.

According to some embodiments of the invention, the BOD controller controls the base station bandwidths in accordance with the updated bandwidths prior to the implementation of the predicted upcoming change.

According to some embodiments of the invention, a data rate change comprises one of a group comprising: establishing a new communication bearer, terminating an existing communication bearer and changing a type of an existing communication bearer.

According to some embodiments of the invention, the signaling monitor predicts a change in data rate upon identifying a request associated with the base station to perform one of a group of actions comprising: open a new bearer, change the type of an existing bearer, and terminate an existing bearer.

According to some embodiments of the invention, the signaling monitor predicts a change in data rate upon identifying approval associated with the access controller of one of a group comprising: a request associated with the base station to open a new bearer, a request associated with the base station to change the type of an existing bearer, and approval of a request associated with the base station to terminate an existing bearer.

According to an aspect of some embodiments of the present invention there is provided a communication network with bandwidth management, the communication being over communication channels established toward base stations, comprising: a plurality of base stations, configured for communicating via the network over communication channels, at least one of the base stations having a dynamically-allocatable respective bandwidth for the communicating; an access controller associated with the plurality of base stations, configured for managing communication resources for the base stations; a plurality of signaling monitors, each of the signaling monitors being associated with a respective base station and configured for monitoring signaling between the respective base station and the access controller and predicting upcoming changes to a bandwidth of the respective base station in accordance with the monitored signaling; and a bandwidth allocator associated with the signaling monitors, configured for updating the respective dynamically-allocatable bandwidths in accordance with the predicted upcoming changes.

According to some embodiments of the invention, the dynamically-allocatable respective bandwidths comprise bandwidths for transmissions over a satellite portion of the communication network.

According to some embodiments of the invention, the bandwidth allocator provides the updated bandwidths to a BOD controller.

According to some embodiments of the invention, the BOD controller controls the base station bandwidths in accordance with the updated bandwidths prior to the change in bandwidth needs.

According to some embodiments of the invention, the signaling monitors are configured to provide the identified upcoming changes to the bandwidth allocator.

According to some embodiments of the invention, the bandwidth allocator is configured for aggregating information received from the plurality of signaling monitors regarding the identified upcoming changes and for allocating the updated bandwidths in accordance with the aggregated information.

According to some embodiments of the invention, a signaling monitor predicts a change in data rate upon identifying a request associated with the respective base station to perform one of a group of actions comprising: open a new bearer, change the type of an existing bearer, and terminate an existing bearer.

According to some embodiments of the invention, a signaling monitor predicts a change in data rate upon identifying approval by the access controller of one of a group comprising: a request associated with the respective base station to open a new bearer, a request associated with the respective base station to change the type of an existing bearer, and approval of a request associated with the respective base station to terminate an existing bearer.

According to an aspect of some embodiments of the present invention there is provided a method for controlling bandwidth allocation for a communication network, the communication network comprising an access controller communicating with at least one base station to provide data communication over the communication network, each of the base stations having a respective allocated bandwidth for the communicating, comprising: monitoring signaling between at least one of the communication network base stations and the access controller; predicting a change in data rate of at least one of the monitored base stations in accordance with the monitored signaling; and updating an allocated bandwidth of at least one of the communication network base stations in accordance with the predicted change.

According to some embodiments of the invention, the respective allocated bandwidths comprise bandwidths for transmissions over a satellite portion of the communication network.

According to some embodiments of the invention, the updating prior is performed prior to the implementation of the predicted change.

According to some embodiments of the invention, the predicting comprises identifying a message indicative of a data rate change transferred between the base station and the access controller.

According to some embodiments of the invention, the message indicative of a data rate change comprises one of a group comprising: a request associated with a base station to open a new bearer, a request associated with a base station to change the type of an existing bearer, and a request associated with a base station to terminate an existing bearer.

According to some embodiments of the invention, the message indicative of a data rate change comprises one of a group comprising: approval of a request associated with a base station to open a new bearer, approval of a request associated with a base station to change the type of an existing bearer, and approval of a request associated with a base station to terminate an existing bearer.

According to some embodiments of the invention, the updating comprises determining a required bandwidth for the base station in accordance with existing bearers and the predicted change.

According to some embodiments of the invention, the updating is further in accordance with specific network parameters.

According to some embodiments of the invention, the method further comprises managing quality of service prioritizations in accordance with at least one of: an updated allocated bandwidth and a predicted upcoming change to a communication resource.

According to some embodiments of the invention, the method further comprises changing a bandwidth of the base station to the allocated bandwidth.

According to some embodiments of the invention, the method further comprises decreasing an allocated bandwidth of the base station upon non-occurrence of a predicted upcoming change.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIGS. 1A and 1B show performance data recorded for a prior art BOD cellular communication system;

FIG. 2 illustrates a simplified GSM satellite cellular system;

FIG. 3 is a simplified block diagram of a bandwidth manager, according to an embodiment of the present invention;

FIG. 4 is a simplified flowchart of the setup of a base station bearer (implemented in signaling protocol);

FIGS. 5A and 5B are simplified block diagrams of a bandwidth management system, according to respective embodiments of the present invention;

FIG. 6 is a simplified block diagram of a communication network with bandwidth management, according to an embodiment of the present invention;

FIGS. 7A and 7B respectively are simplified block diagrams of exemplary UMTS and GSM systems having a bandwidth manager at the base station, according to embodiments of the present invention;

FIG. 8 is a simplified block diagram of a communication network with bandwidth management at the access controller, according to an embodiment of the present invention;

FIGS. 9A and 9B respectively are simplified block diagrams of exemplary UMTS and GSM systems having a bandwidth manager near the access controller, according to embodiments of the present invention; and

FIG. 10 is a simplified flowchart of a method for controlling bandwidth allocation of satellite backbone for a cellular communication network, according to an embodiment of the present invention.

### DESCRIPTION OF SPECIFIC EMBODIMENTS OF THE INVENTION

The present invention, in some embodiments thereof, relates to a system and method for bandwidth on demand for communication networks and, more particularly, but not exclusively, to monitoring signaling within the communication network to provide bandwidth on demand over a satellite transport backbone.

In BOD systems timing for the allocation of additional bandwidth is very significant. A delay in increasing the allocated bandwidth may lead to data loss (e.g. packet loss) if the actual bandwidth utilization increases before the new bandwidth allocation is completed.

The claimed embodiments of the present invention solve problems encountered when implementing BOD in a cellular backhauling system via satellite (e.g. packet loss causes calls drop).

The signaling protocol between base stations and access controller is monitored to predict upcoming changes in base station bandwidth needs, and allocated accordingly the desired bandwidth for Satellite Transport Backbone (i.e. the RF link between the VSAT modems to HUB via satellite) prior to the actual increase in bandwidth needs. This may prevent or decrease packet loss caused by exceeding the currently allocated bandwidth.

Embodiments described herein enable managing bandwidth resources of satellite backbone to provide the desired bandwidth to base stations via VSAT modem, in order to accommodate upcoming changes in base station needs.

Signaling between base stations and the access controller is monitored passively (without disturbing the communication of the cellular network) to analyze and predict upcoming changes in base station bandwidth needs, and base station bandwidths are updated accordingly.

The updated bandwidths are then provided to the appropriate VSAT (associated with a base station). This method of allocation of required system resources prior to the actual increase in bandwidth needs prevents or decreases packet loss caused by exceeding the currently allocated bandwidth.

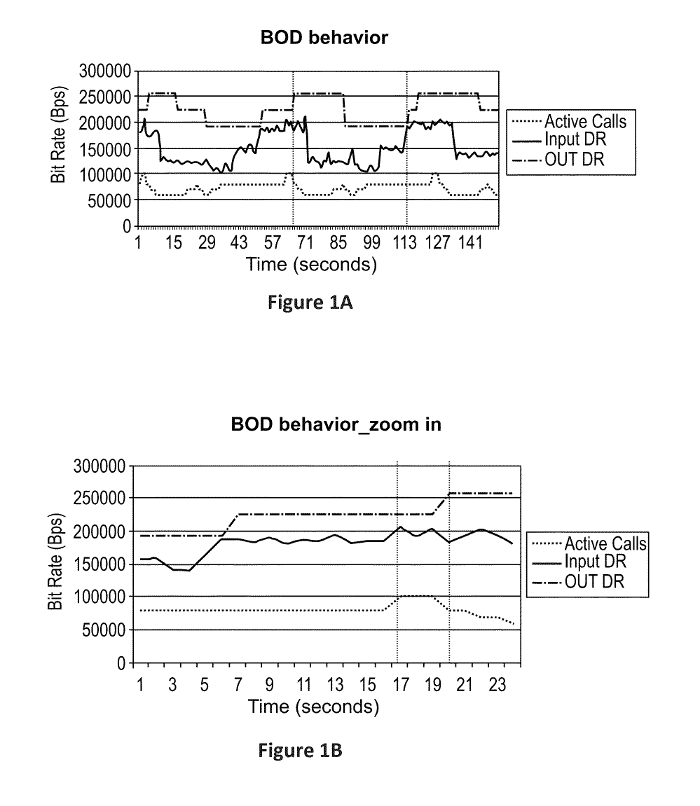

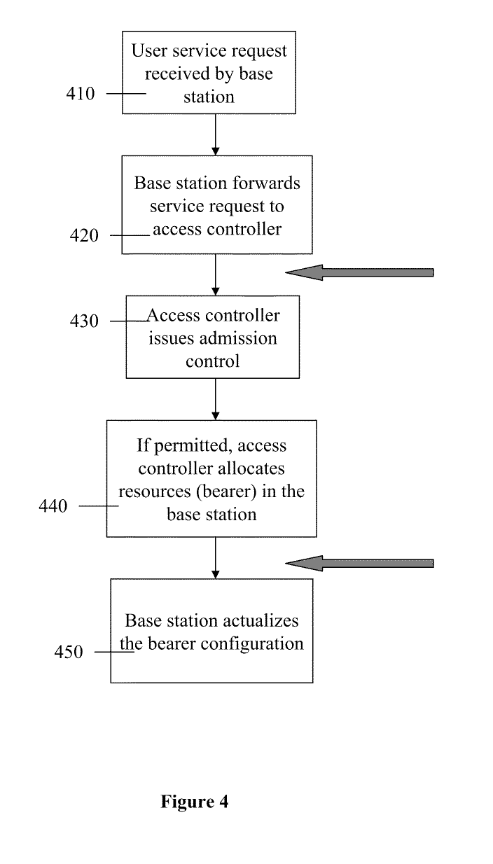

For purposes of better understanding some embodiments of the present invention, as illustrated in FIGS. 3-10 of the drawings, reference is first made to FIGS. 1A and 1B which show performance data recorded for a prior art BOD cellular communication system. The solid line shows the input data rate whereas the dashed line (labeled OUT DR) shows the allocated data rate.

As seen in FIG. 1A, during regular operation actual bandwidth typically follows the required bandwidth. Thus during the majority of time proper operation is achieved. However FIG. 1B shows an expanded view of a period in time in which a rapid increase in the input data rate causes the input data rate to exceed the allocated bandwidth. In order to maintain an allocated bandwidth which is higher than the input bandwidth, additional bandwidth is allocated whenever the input bandwidth passes a specified threshold (not shown in figure). The allocated bandwidth at the beginning of the recording is 200 Kbps. At 7 seconds the threshold of 180 Kbps is exceeded, so the allocated BW is increased to 220 Kbps with a new threshold of 200 Kbps. Due to a rapid rise in the input data rate, at 17 seconds the input data rate exceeds the threshold of 200 Kbps so the allocated bandwidth should be 256 Kbps. However in actuality the 256 Kbps bandwidth is not allocated until 20 seconds. This results in data loss during the three second period in which the input data rate exceeds threshold.

The term bearer as used herein is a set of parameters used by the network to reserve network resources associated with one or more traffic flows (signaling messages, IP packets, media flows etc.). The bearer reservation serves to guarantee specific quality of service behavior upon transferring information associated with the bearer. A distinction is made herein between the signaling bearer and the data bearer based on the type of messages to be carried.

To briefly describe a signaling protocol, consider a cellular communication network in which a user attempts to make a new telephone connection. The user initiates the telephone connection. Typically, the new connection is established by the cellular communication network as follows. First a signaling bearer is set up. Next a data bearer is set up for data transfer. After the signaling and data bearers are set up, a connect message is sent causing the telephone to ring on the receiving end. If the receiving user answers, the connection is completed. It is only after the receiving user answers that data transfer begins and additional bandwidth is required. When the call ends, the data and signaling bearers are released.

It is seen that a period of time, generally of a number of seconds, goes by from the initiation of the call by the user until the actual increase in data rate occurs. The embodiments described herein utilize the time period during which the call is being established in order to increase the allocated bandwidth before connection is completed. Thus the allocated bandwidth may be increased prior to the actual increase in data input, which occurs after the connection is established.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

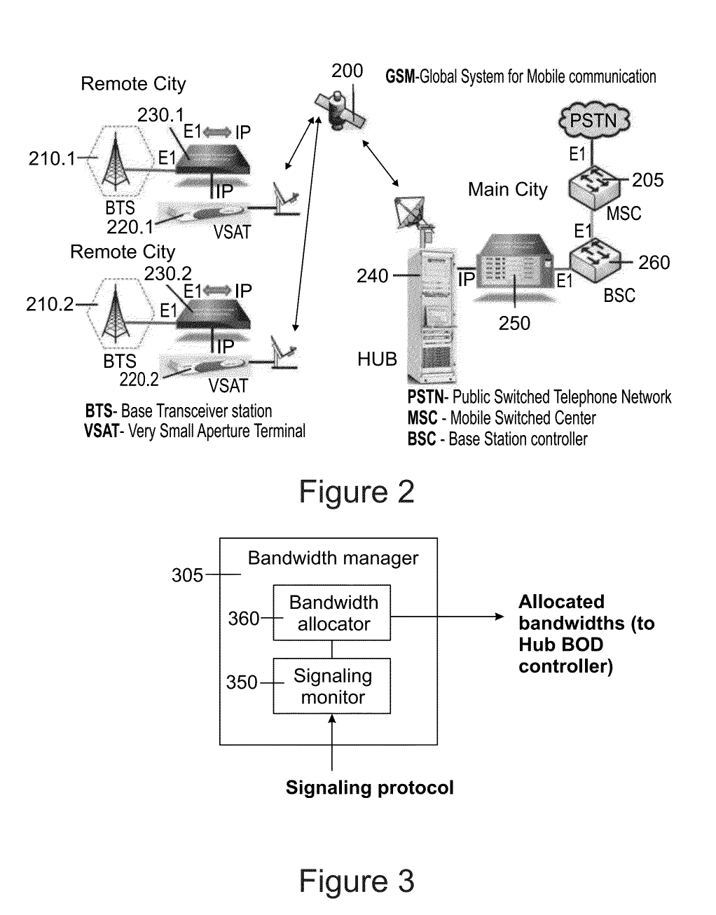

For purposes of explanation, reference is now made to FIG. 2 which illustrates a simplified a GSM satellite cellular system. Satellite 200 communicates between access controller (here labeled BSC) 260 (typically located in a central location) and base stations 210.1 and 210.2. At the base station, the satellite traffic is received/transmitted by Very Small Aperture Terminal (VSAT) modem 220, and conveyed to and from base station 210 via IP to E1 converter 230. At the MSC 205, the satellite traffic is received/transmitted through hub 240, and conveyed to and from BSC 260 via IP to E1 converter 250.

The description below is directed to embodiments for cellular communication networks. However these embodiments are not intended to be limiting. Additional embodiments may be implemented on other types of networks which accommodate data transfer with limited bandwidth. Such networks may include networks with IP Multimedia Subsystem (IMS) compliant access technologies (e.g. IP-CAN), satellite networks, microwave networks, optical networks and line traffic networks.

As used herein the term “access controller” denotes a system element which controls the base station. Different types of networks may utilize different terminologies for the similar or corresponding elements (e.g. Radio Station controller in a UMTS network or BSC in a GSM network), and the term access controller is intended to include all such similar or corresponding elements.

Reference is now made to FIG. 3, which is a simplified block diagram of a bandwidth manager, according to an embodiment of the present invention. Bandwidth manager 305 allocates bandwidth within a satellite transport backbone. The satellite transport backbone (not shown) includes the VSAT modems and Hub which may be connected to the core network either directly or via the access controller. Each of the VSAT modems (associated with a base station) has a respective allocated bandwidth which may be controlled during operation by bandwidth manager 305.

The access controller manages aspects of the operation of the base stations, including the establishment, modification and termination of data bearers to the base station. Communication between the access controller and the base stations takes place over a signaling bearer or bearers established to the base stations.

In some embodiments, the cellular communication network is a Universal Mobile Telecommunications System (UMTS) network, the access controller is a Radio Network Controller (RNC) and the base stations are Node Bs. In some alternate embodiments the cellular communication network is a Global System for Mobile communication (GSM) network, the access controller is a Base Station Controller (BSC) and the base stations are base transceiver stations (BTS).

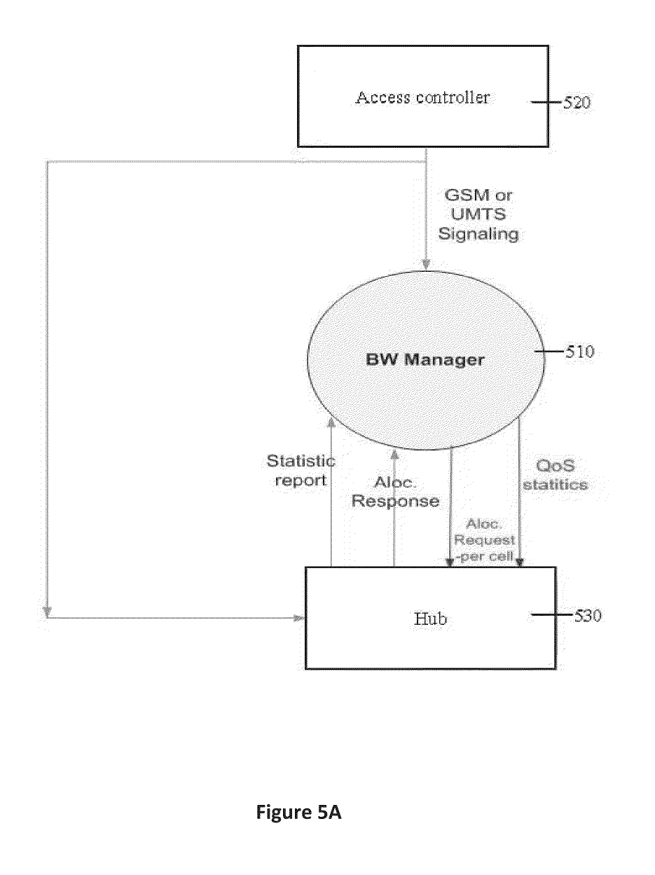

Reference is now made to FIG. 4, which is simplified flowchart of the setup of a base station bearer (signaling protocol). FIG. 4 presents a non-limiting example of signaling between a single access controller and a single base station. Although FIG. 4 describes a bearer setup, similar processes take place for terminating an existing data bearer or changing the nature of the bearer, such as a change from Internet access to voice over IP (VoIP).

In 410 a user service request requiring the setup of a new connection is received. Typically this connection takes place by first establishing a signaling bearer and then a data bearer. In 420, the base station forwards the service request to the access controller. The access controller ascertains if the setup is permitted. In 430 the access controller issues admission control. Admission control is an authorization procedure that is performed by the access controller upon every service request (or service modification) to verify that there are enough resources that can be allocated for the new/modified bearer associated with the service request. This may serve as a QoS mechanism to ensure or maintain a level of voice or data quality.

If the service request permitted, in 440 the access controller allocates resources (bearers and/or bandwidth reservation) in the base station. The base station then actualizes the bearer configuration in 450 and the connection is established for the user.

The sideways arrows in FIG. 4 indicate the points at which signaling is taking place between the base station and access controller. This signaling includes:
1) Service Request received from the user;
2) Bearer Assignment received from the core network;
3) Bearer modification by the core network due to service-related events;
4) Bearer modification by the access controller due to access-related events;
5) Flow Control and Congestion indication exchanged between Base Station and the Access Controller; and
6) Bearer Release and Connection Release messages.

These messages occur before the resource is allocated or modified in 450, and may be used as indicators of an upcoming need for increased bandwidth.

An embodiment is now described in the context of a single access controller controlling the operation of a single base station. It is to be understood that other embodiments are possible for larger and more complex cellular communication networks, and may include multiple base stations and/or multiple access controllers.

Returning to FIG. 3, bandwidth manager 305 includes signaling monitor 350 and bandwidth allocator 360. Signaling monitor 350 monitors messages over the signaling bearer between one or more base stations and the access controller. Signaling monitor 350 identifies signaling between the base station(s) and the access controller which are indicators of upcoming events which may cause changes in data rate (i.e. changes to required bandwidth). Signaling monitor 350 may also monitor bearer characteristics, such as priority, transport addresses, DiffServ Code Points, maximum/Guaranteed Bit Rate (GBR) and estimate the effective bandwidth. The specific signaling, messages and/or data monitored by signaling monitor 350 may be selected according to network requirements, type of network and signaling protocols. The Priority Bit Rate (PBR) is typically associated with a bearer allocated to the user, and thus may serve for determining the bandwidth required by the bearer. The bearer may be mapped to a radio channel (e.g. telephony over a dedicated channel) or to a virtual resource (e.g. IP flow over a shared channel). The aggregated PBR of all active bearers in a cell may be used as an estimation of the satellite transport bandwidth required.

Exemplary messages which may be monitored include:
1) Bearer activation—new reservation of resources (indicative of future increase in required bandwidth).
2) Bearer modification—modification to an existing resource reservation (indicative of future increase or decrease in data rate, dependent upon the type of change).
3) Bearer termination—indicating release of existing resource reservation (indicative of future decrease in the required bandwidth).

Signaling monitor 350 analyzes the relevant messages and parameters from the signaling protocol, to predict changes in the base station data rate. For example, a bearer activation message may result in a prediction of an increase base station data rate. A bearer modification may result in a prediction of an increase or decrease in base station bandwidth, depending on the type of change which is occurring in the existing bearer (e.g. a fallback from video call to telephony may cause a decrement in the data rate). A decrease in data rate may be predicted upon occurrences such as bearer release, connection release or other flow control indications between the base station and the access controller that indicate reduced average throughput.

Typically, when BOD is employed in the satellite system the network hub includes a BOD controller for managing the bandwidth of RF satellite link. Based on the predictions by signaling monitor 350, bandwidth allocator 360 provides the BOD controller with the updated bandwidths to be allocated over the satellite transport backbone to the monitored base stations. BOD controller may aggregate the information from bandwidth allocator 360 and other sources, and decides accordingly (based on priority, type of service, etc. . . . ) if and how to allocate the RF satellite bandwidth.

The terms which describe the activities of the bandwidth allocator (e.g. update/modify/increase/decrease the allocated bandwidth) mean that new bandwidth parameters are selected by the bandwidth allocator, but do not include controlling the network resources based on the selected parameters.

When the addition of a new bearer is predicted, bandwidth allocator 360 requests to increase the bandwidth of the base station (i.e. the bandwidth of the appropriate VSAT modem) for implementation of the desired bandwidth prior to the actual usage of the bearer. Thus at the moment that the bearer is established the allocated bandwidth is already adequate for the resulting increase in data rate, and no packet loss or other bandwidth overload issues occur. Similarly, bandwidth allocator 360 may increase the base station's respective bandwidth when signaling monitor 350 predicts that the data rate will rise on an existing bearer due to a change in the type of bearer characteristics. If the signaling monitor 350 detects that the predicted bearer setup or change in bearer type was not completed, bandwidth allocator 360 may release the allocated bandwidth.

In some embodiments, bandwidth allocator 360 allocates some bandwidth reserves prior to the implementation of the predicted upcoming change. For some critical resources it is desired that the necessary bandwidths be already in place at the base station(s) at the time that the change occurs (for example when the new connection is established), in order to prevent loss of critical information and eventually a connection loss.

In an embodiment, signaling monitor 350 analyzes a bearer modification request and identifies an upcoming impact on the total resources required by a base station. Bandwidth allocator 360 then modifies the Hub BOD Controller of the allocated bandwidth in accordance with the upcoming impact indicated by the analysis.

In typical networks, the access controller controls multiple base stations. In this case, bandwidth allocator 360 must distribute the total available bandwidth amongst the various base stations. In addition to the predictions provided by signaling monitor 350, bandwidth allocator 360 may utilize additional parameters such as PBR, prioritization and type of service. A prediction of upcoming increase in data rate may therefore not result in an automatic increase in allocated bandwidth, if other base station needs or other parameters prevent the increase. For example, higher priority services may allocate a larger bandwidth than low priority services, even if their current or predicted data rate requirements are equivalent. This enables bandwidth manager 305 to assist in the implementation of other network functions such as Quality of Service (QoS).

Quality of service is the ability to provide different priority to different applications, users, or data flows, or to guarantee a certain level of performance to a data flow. Quality of Service allocations are of major significance when the available bandwidth is limited, especially for delay sensitive applications such as telephony and Voice-over-IP.

Knowledge (or prediction) of upcoming changes in the type and quantity of services requested by users may be utilized for implementing QoS prioritization. In some embodiments a QoS implementer is provided with information regarding upcoming changes in user service requirements and/or base station allocations. Early knowledge that the allocated bandwidth is about to be exceeded, enables the QoS application to more effectively prepare for the dealing with the issues which will arise. The QoS application may receive detailed information on a bearer level, enabling finely-tuned allocation on a user-by-user or service-by-service basis.

Parameters that may impact Quality of Service prioritizations include:
1) Type of Service;
2) Allocation/retention priority of the service data flow;
3) Type of Radio Bearer allocated;
4) Dynamic rate changes reflected by the flow-control negotiation between base station and access controller; and
5) QoS characteristics associated with the requested bearer (e.g. PBR, MBR, GBR).

Bandwidth allocator 360 provides the updated bandwidths to a hub BOD controller which implements the required changes.

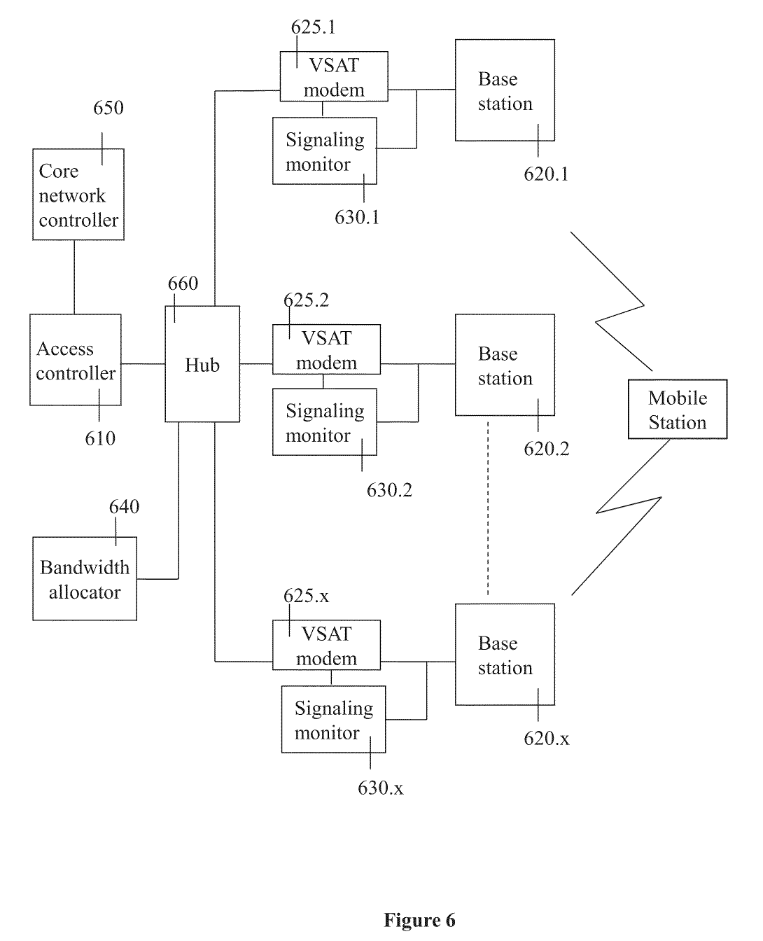

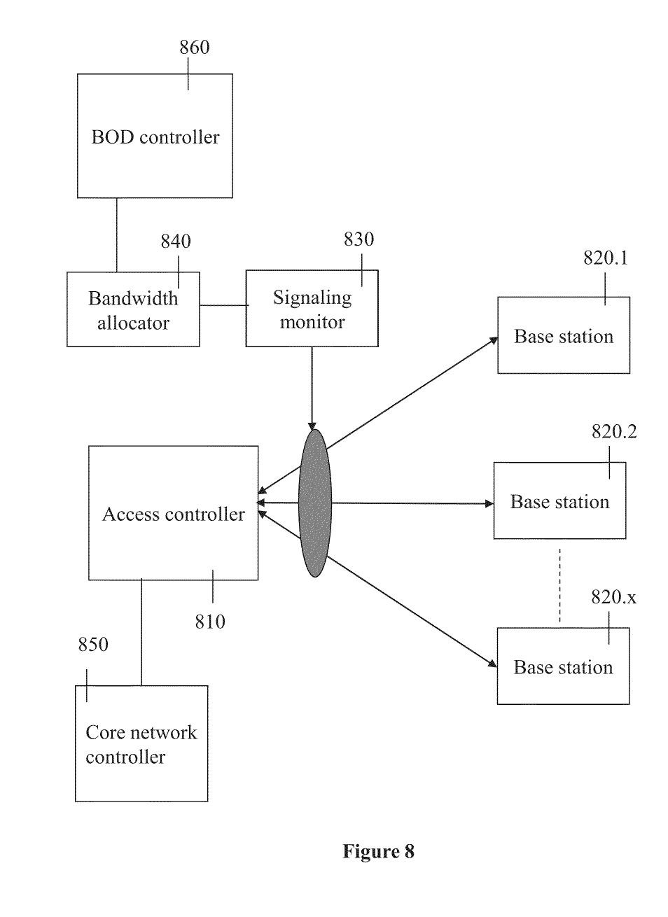

Bandwidth manager 305 may be positioned at any location within the network that allows it to monitor the signaling between the access controller and the base stations and to provide the bandwidth updates to a network control component for implementation. In some embodiments, signaling monitor 350 and bandwidth allocator 360 are co-located (e.g. see FIG. 8) whereas in other embodiments signaling monitor 350 and bandwidth allocator 360 are located in separate locations within the network (e.g. see FIG. 6). This enables, for example, locating a signaling monitor 350 at each base station to monitor each base station separately, and utilizing a single bandwidth allocator located at the access controller.

In some embodiments a signaling monitor is located at each base station (e.g. see FIG. 6). Additionally or alternately, in some embodiments a bandwidth manager, which includes the signaling monitor and the bandwidth allocator, is located at the access controller (e.g. see FIG. 8). Embodiments of such configurations are described below.

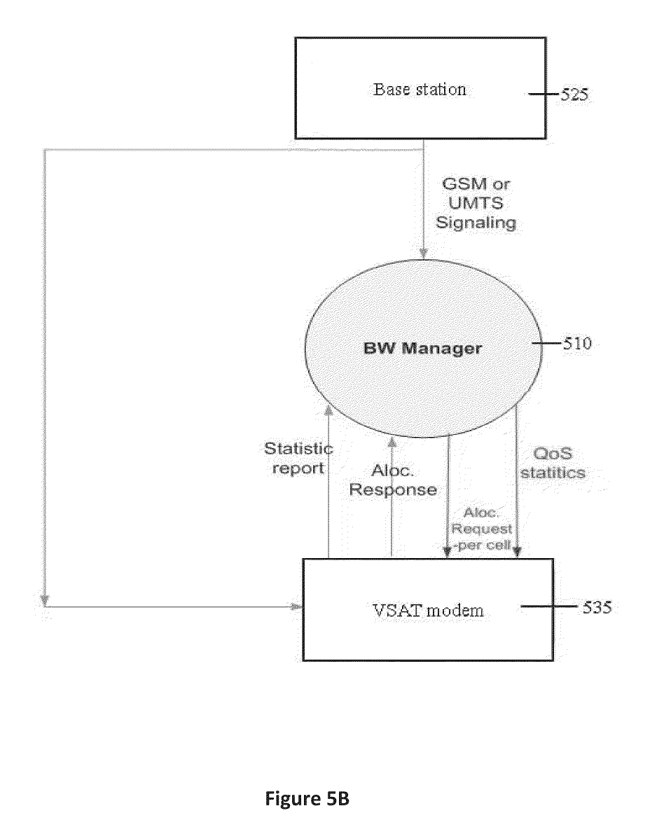

Reference is now made to FIGS. 5a and 5b, which are simplified block diagrams of a bandwidth management system according to respective embodiments of the present invention. In FIG. 5a bandwidth manager 510 monitors GSM or UMTS signaling (or any other type of access network) between access controller 520 and network hub 530. In FIG. 5b bandwidth manager 510 monitors GSM or UMTS signaling (or any other type of access network) between base station 525 and VSAT modem 535. In addition to allocation requests and allocation responses, bandwidth manager 510 receives input such as statistic reports and QoS statistics. Bandwidth prediction, allocation and updating may take into account all of the available information.

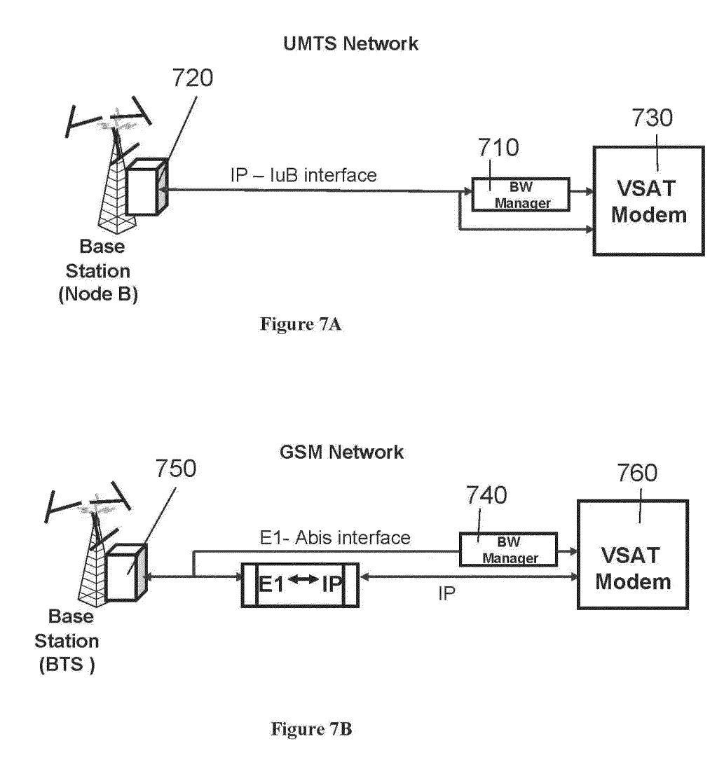

Reference is now made to FIG. 6 which is a simplified block diagram of a cellular communication network with bandwidth management, according to an embodiment of the present invention. Communication takes place over signaling connections established between network nodes and the base stations. The embodiments of FIGS. 6-7 one or more signaling monitors located at the base stations (remote sites) while the bandwidth allocator is associated with the hub. Data is provided from the signaling monitor(s) to the bandwidth allocator over the communication link.

The present embodiment includes multiple base stations 620.1-620.x. Each base station 620.1-620.x has a dynamically-allocatable respective bandwidth.

Communication resources to the base station are managed (e.g. established, modified and terminated) by access controller 610. Note that in some embodiments connections may be formed with a base station outside the network shown.

Each of base stations 620.1-620.x is associated with a respective signaling monitor 630.1-630.x. Each signaling monitor 630 monitors the signaling between the associated base station 620 and access controller 610 and predicts upcoming changes to a data rate of the associated base station, substantially as discussed above. The signaling data collected by the signaling monitor(s) is provided to bandwidth allocator 640, via the associated VSAT modem 625 for transmission to hub 660.

Each signaling monitor 630 identifies requests associated with its associated base station to establish, terminate or modify an existing bearer. Corresponding predictions as to an increase, decrease or appropriate change in the required bandwidth are then made. Similarly the predictions may be made based on the signaling response returned by access controller 610 which confirms the respective base station's request, or other indicative signaling between the base station and core network controller 650.

Bandwidth allocator 640 updates respective bandwidths for one or more base stations in accordance with the predicted upcoming changes. Bandwidth allocator 640 aggregates the information provided by signaling monitors 630.1-630.x. This aggregated information is used by the BOD controller for bandwidth allocation.

Positioning the signaling monitor near the access controller may assist in implementation of QoS services. This is because the QoS monitoring information must be fed to the hub QoS mechanism (near the access controller) prior to traversing the satellite link.

The network may further include base stations without an associated signaling monitor, to which the bandwidth is allocated without monitoring of the signaling in and out of the base station (not shown). Additionally or alternately, the network may further include base stations that do not have a dynamically-allocatable bandwidth (not shown).

Exemplary UMTS and GSM systems having a bandwidth manager at the base station are shown in FIGS. 7a and 7b respectively. In the case of a UMTS network, signaling monitor 710 (labeled BW manager) is located at Node B base station 720, and monitors the signaling to the access controller via VSAT modem 730. In the case of a GSM network, signaling monitor 740 (labeled BW manager) is located at BTS base station 750, and monitors the signaling the access controller to VSAT modem 760. In both FIGS. 7a and 7b the predictions are transferred by the VSAT modem to the hub over the communication link for the remainder of the bandwidth allocation and control process.

Reference is now made to FIG. 8 which is a simplified block diagram of a communication network with bandwidth management at the access controller, according to an embodiment of the present invention. Similarly to the above-described embodiment of FIG. 6, the present embodiment includes multiple base stations 820.1-820.x, with dynamically-allocatable respective bandwidths. Communication resources to the base station are managed by access controller 810. Access controller 810 is associated with core network controller 850 (e.g. MSC for 3G networks).

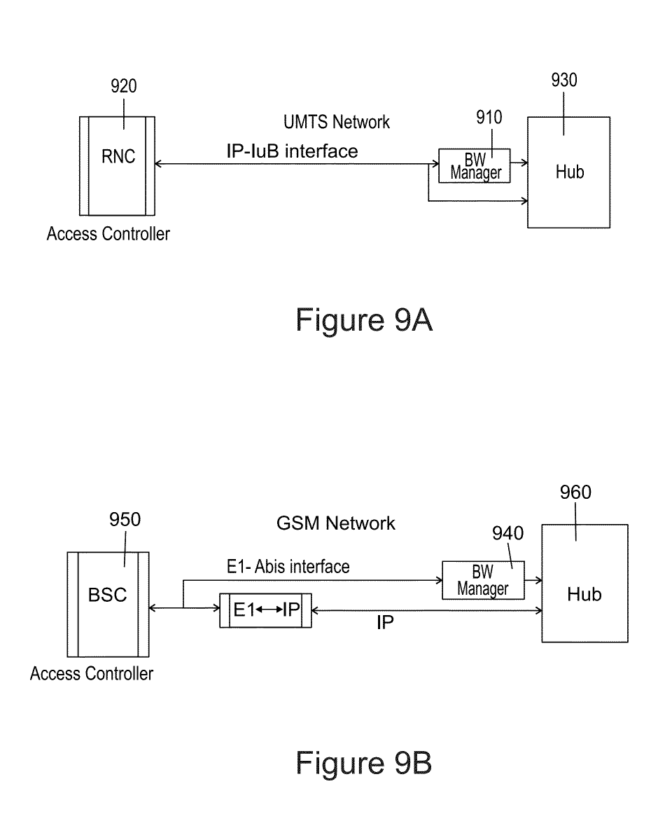

The embodiments of FIGS. 8-9 utilize signaling monitor 830 at the access controller 810 (central site).

Communication between access controller 810 and base stations 820.1-820.x takes place over signaling bearers.

In the present embodiment, signaling monitor 830 is associated with bandwidth allocator 840. Signaling monitor 830 monitors aggregated signaling between the access controller 810 and each of the base stations 820.1-820.x to predict upcoming changes to respective data rates of each of the base stations. Upcoming changes to the data rate of each base station are predicted by signaling monitor 830 substantially as discussed above.

Bandwidth allocator 840 is notified by signaling monitor 830 of the predictions, so as to enable updating the respective bandwidths (in the satellite transport backbone) in accordance with the upcoming changes.

By positioning the signaling monitor 830 near access controller 810, data for multiple base stations may be collected at a single location. Similarly, positioning bandwidth allocator 840 near access controller 810 permits updated bandwidths to be provided to BOD controller 860 for implementation.

Exemplary UMTS and GSM systems having a bandwidth manager near the access controller are shown in FIGS. 9a and 9b respectively. In the case of a UMTS network, bandwidth manager 910 is located between access controller 920 (i.e. RNC) and hub 930 monitors the signaling protocol using an IP protocol. In the case of a GSM network, bandwidth manager 940 is located between access controller 950 and hub 960, and monitors signaling protocol. The bandwidth manager monitors signaling between the access controller and the base station(s), analyzes the signaling and other parameters to predict data rate changes for each base station. These predictions are provided to the BOD controller in the hub to implement bandwidth allocation and timing for each base station, and possibly for implementing a QoS mechanism.

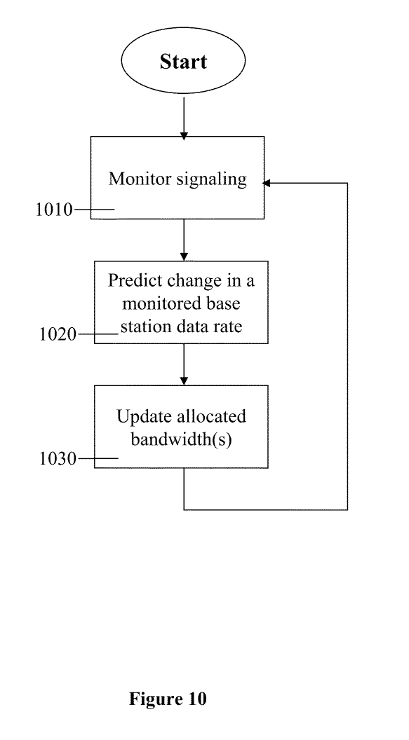

Reference is now made to FIG. 10, which is a simplified flowchart of a method for controlling bandwidth allocation of satellite backbone for a cellular communication network according to an embodiment of the present invention. The cellular communication network includes an access controller communicating with at least one base station to provide data communication. Each base station has a respective allocated bandwidth for the communicating.

In 1010, signaling between at least one base station and the access controller is monitored. In 1020, a change in the bandwidth required for a monitored base station is predicted in accordance with the monitored signaling. Upcoming changes to the data rate of each base station are predicted substantially as discussed above. In 1030, the allocated bandwidth of at least one of the base stations is updated in accordance with the predicted change and monitoring continues. The updating may be performed for the bandwidth of a monitored base station and/or of a non-monitored base station.

In some embodiments the requested update prediction is modified to cope with restrictions of the base station, restrictions of transmission equipment, etc. . . . .

In networks with multiple monitored base stations, predicted upcoming changes may result in updating of the bandwidth of multiple base stations within the network.

As discussed above, data regarding predictions and bandwidth allocations may be utilized for performing Quality of Service prioritization.

Bandwidth-on-demand enables efficient usage of available bandwidth resources. The embodiments herein provide bandwidth-on-demand which is capable of predicting upcoming changes in resource allocation needs for base stations within the network. These predicted changes may be used to reallocate bandwidth within the network possibly prior to the occurrence of these changes. Furthermore, no fundamental changes are needed in the communication network architecture. Thus data loss due to rapid increases in data rates may be reduced or prevented. The embodiments above may be implemented without making changes to existing network architecture.

It is expected that during the life of a patent maturing from this application many relevant network types, network protocols, network configurations, base stations, access controllers, signaling, bandwidth allocation and bandwidth control will be developed and the scope of the corresponding terms is intended to include all such new technologies a priori.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

1. A bandwidth manager for base stations in a communication network, said base stations being controlled by an access controller to dynamically allocate communication resources for said base stations, each of said base stations having a respective allocated bandwidth, comprising:
a signaling monitor, configured for monitoring signaling between said access controller and at least one of said base stations so as to predict upcoming changes to a demand for communication resources for at least one monitored base station; and
a bandwidth allocator associated with said signaling monitor, configured for updating said respective allocated bandwidths in accordance with said predicted upcoming changes,
wherein said bandwidth allocator is configured to perform said updating prior to the implementation of said predicted upcoming change.

2. A bandwidth manager according to claim 1, wherein said respective allocated bandwidths comprise bandwidths for transmissions over a satellite portion of said communication network.

3. (canceled)

4. A bandwidth manager according to claim 1, wherein said communication network comprises a cellular communication network.

5. A bandwidth manager according to claim 1, wherein said communication network comprises an IP Multimedia Subsystem (IMS) compliant IP access network.

6. A bandwidth manager according to claim 1, wherein said signaling is over a signaling bearer between said access controller and said at least one base station.

7. A bandwidth manager according to claim 1, wherein said predicting comprises identifying signaling messages indicative of one of a resource type change and a resource bandwidth change for said at least one base station.

8. A bandwidth manager according to claim 1, wherein said predicting comprises identifying flow control indications of one of a resource type change and a resource bandwidth change for said at least one base station.

9. A bandwidth manager according to claim 1, wherein said signaling monitor is configured to identify at least one of a bearer activation event, a bearer modification event and a bearer termination event indicative of a resource type change for said at least one base station.

10. A bandwidth manager according to claim 1, wherein said signaling monitor is further configured to analyze a requested bearer modification to identify an upcoming impact upon a total required resources of a base station, and said bandwidth allocator is configured to modify an allocated bandwidth of said base station in accordance with said identified upcoming impact.

11. A bandwidth manager according to claim 1, wherein said signaling monitor is configured to identify a signaling event indicative of an upcoming change in the data rate of an existing bearer of a base station.

12. A bandwidth manager according to claim 1, wherein said signaling monitor is configured to identify a signaling event indicative of an upcoming allocation of a new bearer to a base station.

13. A bandwidth manager according to claim 1, wherein said signaling monitor is configured to identify a signaling event indicative of an upcoming release of an existing bearer of a base station.

14. A bandwidth manager according to claim 1, wherein said signaling monitor is configured to derive a priority bit rate (PBR) associated with a bearer so as to determine a required bandwidth for said bearer.

15. A bandwidth manager according to claim 14, wherein said deriving is from information provided by signaling messages and flow control indications.

16. A bandwidth manager according to claim 1, further comprising a Quality of Service manager configured for implementing differentiation between bearers and quality of services prioritizations in accordance with information provided by signaling messages and flow control indications.

17. A bandwidth manager according to claim 1, wherein said communication network comprises a Universal Mobile Telecommunications System (UMTS) network, said access controller comprises a Radio Network controller (RNC) and said at least one base station comprises a Node B.

18. A bandwidth manager according to claim 1, wherein said communication network comprises a Global System for Mobile communication (GSM) network, said access controller comprises a GSM base station controller (BSC) and said at least one base station comprises a base transceiver station (BTS).

19. A communication network with bandwidth management, said communication being over communication channels established toward base stations, comprising:
a plurality of base stations, configured for communicating over communication channels, at least one of said base stations having a dynamically-allocatable respective bandwidth for said communicating;
an access controller associated with said base stations, configured for managing communication resources for said base stations;
a signaling monitor associated with said access controller, configured for monitoring signaling between said access controller and at least one of said base stations to predict upcoming changes to respective data rates of said monitored base stations; and
a bandwidth allocator associated with said signaling monitor, configured for updating said respective dynamically-allocatable bandwidths in accordance with said predicted upcoming changes,
wherein said bandwidth allocator is configured to provide said updated bandwidths to a bandwidth on demand (BOD) controller and said BOD controller is configured to control said base station bandwidths in accordance with said updated bandwidths prior to the implementation of said predicted upcoming change.

20. A communication network according to claim 19, wherein said dynamically-allocatable respective bandwidths comprise bandwidths for transmissions over a satellite portion of said communication network.

21-22. (canceled)

23. A communication network according to claim 16, wherein a data rate change comprises one of a group comprising: establishing a new communication bearer, terminating an existing communication bearer and changing a type of an existing communication bearer.

24. A communication network according to claim 19, wherein said signaling monitor is configured to predict a change in data rate upon identifying a request associated with said base station to perform one of a group of actions comprising: open a new bearer, change the type of an existing bearer, and terminate an existing bearer.

25. A communication network according to claim 19, wherein said signaling monitor is configured to predict a change in data rate upon identifying approval associated with said access controller of one of a group comprising: a request associated with said base station to open a new bearer, a request associated with said base station to change the type of an existing bearer, and approval of a request associated with said base station to terminate an existing bearer.

26. A communication network with bandwidth management, said communication being over communication channels established toward base stations, comprising:
a plurality of base stations, configured for communicating via said network over communication channels, at least one of said base stations having a dynamically-allocatable respective bandwidth for said communicating;
an access controller associated with said plurality of base stations, configured for managing communication resources for said base stations;
a plurality of signaling monitors, each of said signaling monitors being associated with a respective base station and configured for monitoring signaling between said respective base station and said access controller and predicting upcoming changes to a bandwidth of said respective base station in accordance with said monitored signaling; and
a bandwidth allocator associated with said signaling monitors, configured for updating said respective dynamically-allocatable bandwidths in accordance with said predicted upcoming changes,
wherein said bandwidth allocator is configured to provide said updated bandwidths to a BOD controller and said BOD controller is configured to control said base station bandwidths in accordance with said updated bandwidths prior to the change in bandwidth needs.

27. A communication network according to claim 26, wherein said dynamically-allocatable respective bandwidths comprise bandwidths for transmissions over a satellite portion of said communication network.

28-29. (canceled)

30. A communication network according to claim 26, wherein said signaling monitors are configured to provide said identified upcoming changes to said bandwidth allocator.

31. A communication network according to claim 26, wherein said bandwidth allocator is configured for aggregating information received from said plurality of signaling monitors regarding said identified upcoming changes and for allocating said updated bandwidths in accordance with said aggregated information.

32. A communication network according to claim 26, wherein a signaling monitor is configured to predict a change in data rate upon identifying a request associated with the respective base station to perform one of a group of actions comprising: open a new bearer, change the type of an existing bearer, and terminate an existing bearer.

33. A communication network according to claim 26, wherein a signaling monitor is configured to predict a change in data rate upon identifying approval by said access controller of one of a group comprising: a request associated with the respective base station to open a new bearer, a request associated with the respective base station to change the type of an existing bearer, and approval of a request associated with the respective base station to terminate an existing bearer.

34. A method for controlling bandwidth allocation for a communication network, said communication network comprising an access controller communicating with at least one base station to provide data communication over said communication network, each of said base stations having a respective allocated bandwidth for said communicating, comprising:
monitoring signaling between at least one of said communication network base stations and said access controller;
predicting a change in data rate of at least one of said monitored base stations in accordance with said monitored signaling; and
updating an allocated bandwidth of at least one of said communication network base stations in accordance with said predicted change,
wherein said updating is performed prior to the implementation of said predicted change.

35. A method according to claim 34, wherein said respective allocated bandwidths comprise bandwidths for transmissions over a satellite portion of said communication network.

36. (canceled)

37. A method according to claim 34, wherein said predicting comprises identifying a message indicative of a data rate change transferred between said base station and said access controller.

38. A method according to claim 37, wherein said message indicative of a data rate change comprises one of a group comprising: a request associated with a base station to open a new bearer, a request associated with a base station to change the type of an existing bearer, and a request associated with a base station to terminate an existing bearer.

39. A method according to claim 37, wherein said message indicative of a data rate change comprises one of a group comprising: approval of a request associated with a base station to open a new bearer, approval of a request associated with a base station to change the type of an existing bearer, and approval of a request associated with a base station to terminate an existing bearer.

40. A method according to claim 34, wherein said updating comprises determining a required bandwidth for said base station in accordance with existing bearers and said predicted change.

41. A method according to claim 34, wherein said updating is further in accordance with specific network parameters.

42. A method according to claim 34, further comprising managing quality of service prioritizations in accordance with at least one of: an updated allocated bandwidth and a predicted upcoming change to a communication resource.

43. A method according to claim 34, further comprising changing a bandwidth of said base station to said allocated bandwidth.

44. A method according to claim 34, further comprising decreasing an allocated bandwidth of said base station upon non-occurrence of a predicted upcoming change.
